(19) United States
(12) Patent Application Publication
(10) Pub. No.: US 2009/0003601 A1
(43) Pub. Date: Jan. 1, 2009

(54) ALPHA-MASKED IMAGE MATCHING

(75) Inventors: Stephen James Hardy, West Pymble (AU); Kieran Gerard Larkin, Putney (AU); Stephen Farrar, Telopea (AU); Peter Alleine Fletcher, Rozelle (AU); Tuan Quang Pham, North Ryde (AU)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/145,963

(22) Filed: Jun. 25, 2008

(30) Foreign Application Priority Data
Jun. 29, 2007 (AU) 2007203062

(51) Int. Cl. H04L 9/10

(52) U.S. Cl. 380/243

(57) ABSTRACT

A method and system is disclosed for authenticating a physical medium (1405). The method starts by retrieving (1406) a reference digital signature (1412) previously determined (1403) based upon visual characteristics of an area (1402) of a reference physical medium (1400). A candidate digital signature (1415) is determined based upon visual characteristics of an area (1408) of the physical medium (1405), the area (1408) of the physical medium (1405) being at least partly corresponding to the area (1402) of the reference physical medium (1400). Weight values associated with different parts of at least one of the areas (1402 and 1408) are determined (201). Finally, the candidate digital signature (1415) is compared (1420) with the reference digital signature (1412), wherein the contributing of the parts in the comparison (1420) is based upon the weight values.

### FIELD OF THE INVENTION

The present invention relates to authenticating a physical medium of a document and, in particular, to a method of using alpha masked correlation when determining the degree of resemblance between the digital signature of a reference physical medium and the digital signature of a candidate physical medium.

### BACKGROUND

The ability to establish the authenticity of a physical medium is critical to a large number of businesses and administrations. Administrative certificates, licences, forms, bank notes, company letterheads, coupons and vouchers all convey an important value in being original. Various techniques already exist to facilitate document authentication. Most conventional certification systems require a physical addition to a document, for example in the form of a bar code, a hologram or a watermark. However, sophisticated counterfeiting techniques often eventually defeat these methods.

Over the last decade, scientists have investigated a different approach to authentication based upon the microscopic characteristics of the paper of the document. During the manufacturing process of paper, the structure of plant fibres is chemically (or mechanically) broken down, diluted and washed out from cellulose. The resulting pulp is then drained through a fine-web screen to form a fibrous sheet. Finally, the water is removed through pressing and drying using regular wire mesh screens. It has been observed that the screens produce a significant imprint onto the paper during the manufacturing process. As a result, fibrous surfaces, such as paper and cardboard, and other media having enough structural unicity, such as for instance plastic, present a complex rough appearance on a microscopic level. The surface singularity of paper is not much affected by time, crushing or abrasion.

The number of possible arrangements of the paper visual characteristics and the fluctuations in the pattern imprinted by the use of screens thus make each area of a sheet of paper unique and therefore identifiable. Likewise, the complexity of the paper visual characteristics makes it very difficult to counterfeit. Examining the visual characteristics of paper in order to establish the authenticity of a document (or to detect counterfeiting) is used in so-called document fingerprinting methods. Typically, at an early stage of a document's lifecycle, a unique digital signature is recorded based on the surface appearance of a selected area of the document. That digital signature is then later compared to a digital signature obtained from a corresponding area in a candidate document.

Some document fingerprinting methods exploit the unique speckle pattern produced by shining laser light onto plain paper, allowing a test to be developed for matching a strip of paper with its previously-scanned “fingerprint”. Other techniques have achieved similar results at lower cost without requiring the use of coherent light, making it possible to authenticate a paper fingerprint created using a standard scanner or photocopier.

Evaluating the matching between two paper fingerprints is typically done using statistical correlation. The random distribution of paper fibres appears interestingly similar to noise images. As a result, correlation provides a very sharp peak when the digital signatures match.

Along its lifecycle, a sheet of paper may undergo a number of accidental or deliberate modifications. For instance, a sheet of paper may be, in turn, imprinted with a company letterhead, re-printed with some text and finally stamped. Likewise, the document may be manually annotated, signed, stained, crushed, torn, etc. The alterations may occur before or after the digital signature was extracted and stored.

Prior techniques have been developed for extracting a digital signature from a printed part of a document, based upon the microscopic non-uniformity of toner. The electro-photographic process comprises several steps amongst which the development, the transfer and the fusing (or fixing), wherein the toner passes through electromagnetic fields, causing uncontrollable scattering of toner gains, and resulting in an unevenness of linear patterns only visible under a microscope. Although ink-jet printing technologies are substantially different, a similar artefact occurs due to the non-uniform penetration of ink. Therefore, even when printing the same pattern twice, the distribution of individual toner points cannot be fully controlled and varies substantially. It has been shown that it is possible to exploit the local non-evenness of printed patterns in order to extract a reliable fingerprint. For instance, the fingerprint can consist of a feature vector computed from a mosaic of tiles that maps a certain area along the edges of the printed pattern, wherein each tile conveys a toner density value.

However, depending on the purpose and usage conditions of a document, an area that served to extract a reference digital signature may undergo substantial modification or alteration after the digital signature was extracted. Examples of modifications include—but are not limited to—further printing, stains, perforations, stamps, seals, official marks, signatures, etc. Consider for example a company letterhead paper, or an administrative form, being printed upon or filled in after it has been created. In this instance, the modified area is likely to have a strong influence when evaluating the matching of the digital signatures and naturally, the larger the modified area, the stronger its influence.

The applicant has observed that when printing two different documents with the same piece of text a high correlation value is obtained due to the similarity of the printed areas, even though the sheets of paper are different. Therefore, printed parts may be responsible for false positives. The applicant has furthermore observed that, when a large part of a document is printed after the reference digital signature is extracted, a low correlation value is obtained due to the dissimilarity of the printed areas, even though the paper should be treated as authentic. In this case, the printing is responsible for a false negative.

Prior attempts to eliminate the effects of printing subsequent to extraction of the reference digital signature operate by detecting and ‘filling’ printed areas with an alternative colour or pattern. Such attempts fail when such areas occupy a substantial portion of the total surface, typically more than half.

### SUMMARY

It is an object of the present invention to substantially overcome, or at least ameliorate, one or more disadvantages of existing arrangements.

According to a first aspect of the present disclosure, there is provided a method of authenticating a physical medium, said method comprising steps for:

retrieving a reference digital signature previously determined based upon visual characteristics of an area of a reference physical medium;

determining a candidate digital signature based upon visual characteristics of a selected area of said physical medium, said selected area of said physical medium being at least partly corresponding to said selected area of said reference physical medium; and

comparing said candidate digital signature with said reference digital signature,

wherein said physical medium includes a substantial amount of markings additional to markings included in said reference physical medium.

According to another aspect of the present disclosure, there is provided a method of authenticating a physical medium, said method comprising the steps for:

retrieving a reference digital signature previously determined based upon visual characteristics of an area of a reference physical medium;

determining a candidate digital signature based upon visual characteristics of a area of said physical medium, said area of said physical medium being at least partly corresponding to said area of said reference physical medium;

determining weight values associated with different parts of at least one of said areas; and

comparing said candidate digital signature with said reference digital signature, wherein a contribution of said parts in the comparison is based upon said one or more weight values.

According to still another aspect of the present invention there is provided an apparatus for authenticating a physical medium, said apparatus comprising:

means for retrieving a reference digital signature previously determined based upon visual characteristics of an area of a reference physical medium;

means for determining a candidate digital signature based upon visual characteristics of an area of said physical medium, said area of said physical medium being at least partly corresponding to said area of said reference physical medium;

means for determining weight values associated with different parts of at least one of said areas; and

means for comparing said candidate digital signature with said reference digital signature, wherein a contribution of said parts in the comparison is based upon said one or more weight values.

According to still another aspect of the present invention there is provided a computer program product including a computer readable storage medium having recorded thereon a computer program for implementing a method of authenticating a physical medium, said method comprising the steps for:

retrieving a reference digital signature previously determined based upon visual characteristics of an area of a reference physical medium;

determining a candidate digital signature based upon visual characteristics of a area of said physical medium, said area of said physical medium being at least partly corresponding to said area of said reference physical medium;

determining weight values associated with different parts of at least one of said areas; and

comparing said candidate digital signature with said reference digital signature, wherein a contribution of said parts in the comparison is based upon said one or more weight values.

Other aspects of the invention are also disclosed.

### BRIEF DESCRIPTION OF THE DRAWINGS

One or more embodiments of the present invention will now be described with reference to the drawings, in which:

FIG. 1 shows a schematic flow diagram of processes within an authentication system for verifying the authenticity of a candidate physical medium with respect to an original physical medium;

FIG. 2 shows a schematic block diagram of the authentication system;

FIG. 3 shows a schematic flow diagram of the comparison of digital signatures occurring within the processes of FIG. 1;

FIGS. 4A, 4B and 4C show an example input image corresponding to a digital signature, a binary image produced from that example input image, and an alpha mask produced through dilution respectively;

FIG. 5A shows a structuring element used in the dilution;

FIG. 5B illustrates by way of example the use of the structuring element of FIG. 5A;

FIG. 6 shows a schematic flow diagram of a method of correlating digital signatures;

FIG. 7 shows a schematic flow diagram of an alternative method of correlating digital signatures;

FIG. 8 shows a schematic flow diagram of determining a match strength value and an associated translation value;

FIGS. 9A to 9B illustrate by way of example the determination of the match strength value and associated translation value;

FIG. 10 shows a schematic flow diagram of a further alternative method of correlating digital signatures;

FIG. 11 shows an area of an image obtained through scanning a sheet of paper with printed letters thereon; and

FIG. 12 is a graph showing the relationship between match strength and a measure of printed area coverage, in accordance with one example.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

When authenticating a physical medium of a document, such as the sheet of paper the document is printed on, the physical medium has to be authenticated with respect to an earlier state of that physical medium without the authentication process being influenced by markings, such as printing or handwriting, placed on the physical medium since that earlier state. Similarly, when comparing two physical media with the same or similar markings placed thereon, authentication of the second physical medium with respect to the first physical medium should ignore the fact that the markings on the physical media are the same or similar, and the authentication should fail as the physical media are different. The markings may further include additional intentional or accidental alteration such as for example manual annotations, signatures, stains, crushing, stamping, signing, stapling, binding, sealing, truncating, etc.

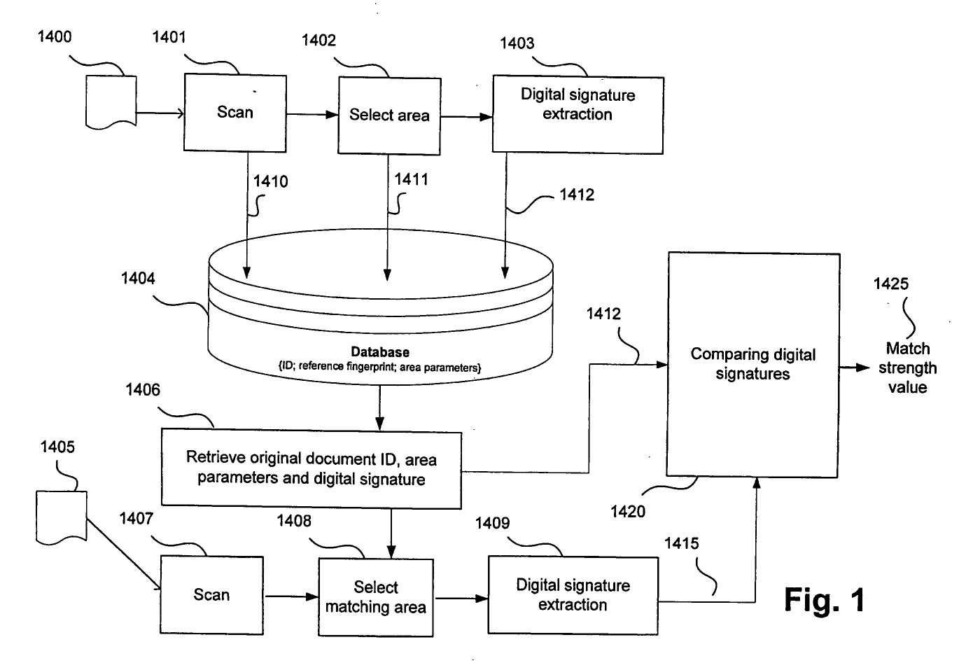

FIG. 1 shows a schematic flow diagram of the processes within an authentication system for verifying the authenticity of a candidate physical medium 1405 with respect to an original physical medium 1400. The authentication system verifies the authenticity of the candidate physical medium 1405 in a manner that is independent upon the markings placed on the physical media 1400 and 1405. The amount of additional markings on the candidate physical medium 1405 when compared with that on the original physical medium 1400 often differs substantially, for instance over 70% of an area under consideration.

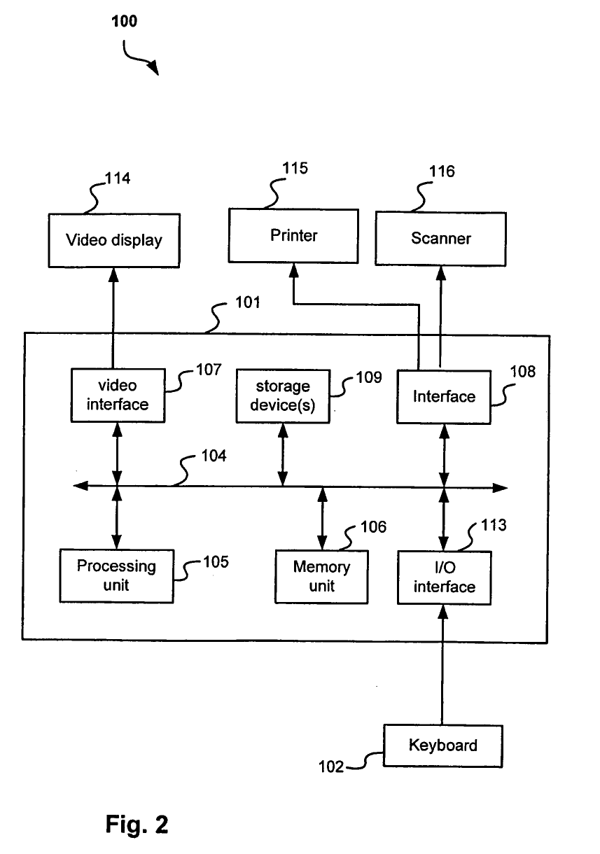

A schematic block diagram of the authentication system 100 is shown in FIG. 2. The authentication system 100 may be a general purpose computer with a scanner 116 attached thereto. Alternatively the authentication system 100 may be a digital photocopier, which essentially comprises a scanner, processing device and a laser printer.

The processes of the authentication system 100 are implemented as software. The software may be stored in a computer readable medium, is loaded into the authentication system 100 from the computer readable medium, and then executed by the authentication system 100. A computer readable medium having such software or computer program recorded on it is a computer program product. The use of the computer program product in the authentication system 100 preferably effects an advantageous apparatus for implementing the authentication system 100.

As seen in FIG. 2, the authentication system 100 is formed by a computer module 101, an input device such as a keyboard 102 or touch sensitive screen (not illustrated), a scanner 116, a printer 115, and a display device 114. The computer module 101 typically includes at least one processor unit 105, and a memory unit 106, and one or more storage devices 109. The authentication system 100 further includes an number of input/output (I/O) interfaces including a video interface 107 that couples to the video display 114, an I/O interface 113 for the keyboard 102, and an interface 108 for the scanner 116 and printer 115.

The interfaces 108 and 113 may afford both serial and parallel connectivity, the former typically being implemented according to the Universal Serial Bus (USB) standards and having corresponding USB connectors (not illustrated). The storage devices 109 may include a hard disk drive (HDD). Other devices such as a floppy disk drive and a magnetic tape drive (not illustrated) may also be used. An optical disk drive (not illustrated) may be provided to act as a non-volatile source of data. Portable memory devices, such optical disks (eg: CD-ROM, DVD), USB-RAM, and floppy disks for example may then be used as appropriate sources of data to the system 100.

The components 105 to 113 of the computer module 101 typically communicate via an interconnected bus 104 and in a manner which results in a conventional mode of operation known to those in the relevant art.

Typically, the software discussed above is resident in the authentication system 100 (e.g., on the hard disk drive) and is read and controlled in execution by the processor 105. In some instances, the software may be supplied to the user encoded on one or more CD-ROM and read via the corresponding drive. Still further, the software can also be loaded into the system 100 from other computer readable media. Computer readable media refers to any storage medium that participates in providing instructions and/or data to the system 100 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 101. Examples of computer readable transmission media that may also participate in the provision of instructions and/or data include radio or infra-red transmission channels as well as a network connection to another computer or networked device, and the Internet or Intranets including e-mail transmissions and information recorded on Websites and the like.

Referring again to FIG. 1, the original physical medium 1400 is scanned in step 1401 using scanner 116 (FIG. 2) to obtain a digital image of the original physical medium 1400. The scanner 116 produces the digital image using incoherent light for illuminating the original physical medium 1400. Also, different scanners 116 typically use slightly different angles of incidence. The incoherent light and difference in angles of incidence cause the digital image produced by different scanners 116 from the same original physical medium to have differences when purely comparing the pixels of the images.

An identifier 1410 is stored in a database 1404 of the authentication system 100. An area within the digital image from which a reference digital signature is to be extracted is then selected in step 1402, and parameters 1411 identifying the selected area is stored in the database 1404 in association with the identifier. In the preferred implementation a rectangular area is selected from the digital image. Any other shape of area may as well be used, such as for example a complex shape matching (or avoiding) a visible pattern or a shape whose geometry is specific to the scanning process (for instance aligned with quantization tiles). A reference digital signature 1412 is extracted and stored in the database 1404 in step 1403, also in association with the identifier. In the preferred implementation the digital signature 1412 is extracted based upon the visual characteristics of the portion of the digital image bounded by the selected area.

At a later moment in time, the authenticity of the candidate physical medium 1405 with respect to a target original physical medium is to be verified. The target original physical medium is identified, via its identifier. The previously determined reference digital signature 1412 and parameters associated with the identifier of the target original physical medium are retrieved from the database 1404 in step 1406.

The candidate physical medium 1405 is scanned in step 1407 using scanner 116. Based on the parameters retrieved in step 1406, an area within the digital image formed by the scan of the candidate physical medium 1405, which at least partly matches the area selected in step 1402, is selected in step 1408. A candidate digital signature 1415 is then extracted in step 1409 from the selected area based upon the visual characteristics of the selected area.

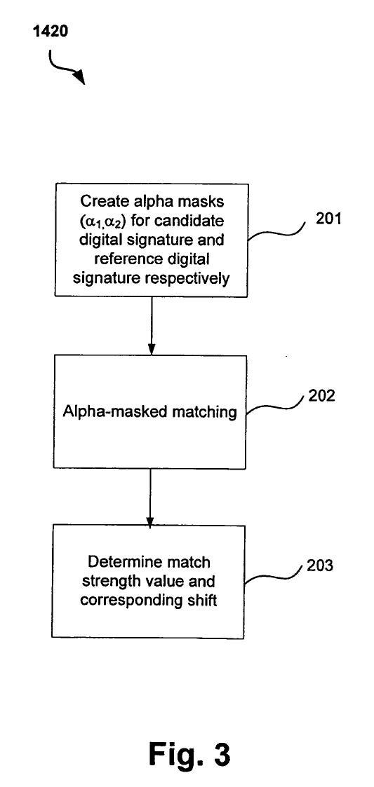

The reference digital signature 1412 and the candidate digital signature 1415 are then compared in step 1420, which outputs a match strength value 1425. Accordingly, the comparison is quantified by the match strength value 1425. Step 1420 is described in more detail below with reference to FIG. 3. The match strength value 1425 is output to a user in the form of an authenticity confidence score on the display 114. Alternatively, the output may merely confirm the authenticity or otherwise of the candidate physical medium 1405 with respect to the reference physical medium 1400.

The processes described above with reference to FIG. 1 select only a single area in the original physical medium 1400. However, a more robust authentication is achieved through selecting a number of areas in step 1402 in the digital image created by the scan of the original physical medium 1400. When authenticating the candidate physical medium 1405, corresponding multiple areas are selected from its digital image in step 1408. The match strength values 1425 derived through the comparison of corresponding digital signatures are then combined, for example through averaging, to provide a total match strength value.

The authentication system 100 described above uses the same components for scanning, and storing the identifier 1410, parameters 1411 and digital signature 1412 of the original physical medium 1400 in the database 1404 as are used for authenticating the candidate physical medium 1405 (steps 1407 to 1420 in FIG. 1). However, two or more authentication systems 100 may be interlinked through a network and sharing the same database 1404. In this manner the storing of original physical medium 1400 data and the authentication of the candidate physical medium 1405 may be performed by different systems 100 and at different locations.

Having described an overview of the processes for verifying the authenticity of the candidate physical medium 1405 with respect to the original physical medium 1400, the comparison of the digital signatures 1412 and 1415 performed in step 1420 is now described in more detail with reference to FIG. 3 where a schematic flow diagram of step 1420 is shown. Step 1420 receives as input the reference digital signature 1412 and the candidate digital signature 1415. Sub-step 201 determines an alpha mask α₁ and α₂ associated with each of the candidate digital signature 1415 and the reference digital signature 1412 respectively. Each alpha mask α₁ and α₂ is a non-negative-valued image α(x, y) ε[0,1]. The first alpha mask α₁ associates a weight to each pixel of the candidate digital signature 1415, and the second alpha mask α₂ associates a weight to each pixel of the reference digital signature 1412.

As an example, an alpha mask value of 0 at a particular pixel signifies that that pixel is removed from consideration when determining the match strength value 1425. Accordingly, the pixel makes no contribution to the match strength value 1425

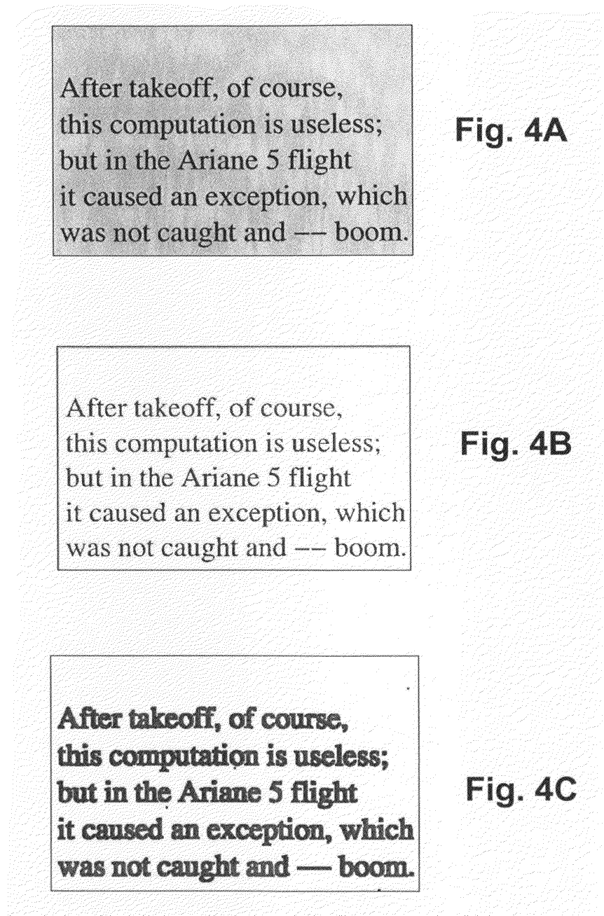

Sub-step 201 produces the binary image from each of the candidate digital signature 1415 and the reference digital signature 1412 respectively by applying a threshold to the digital signatures 1415 and 1412 respectively. In one embodiment, this binary image is intended to capture the pixels potentially covered with toner, or some other masking. Each pixel of the input images (candidate digital signature 1415 and reference digital signature 1412) with a value lower than, or equal to, a pre-set threshold is assigned a value of 0 in the corresponding binary image. Similarly, each pixel of the input images with a value greater than this threshold is assigned a value of 1 in the corresponding binary image. Normally the threshold value is arbitrarily set to 150, with reference to the common level of grey scale. FIG. 4A shows an example input image corresponding to a digital signature 1412 or 1415, and FIG. 4B shows a binary image produced from that example input image.

The toner along the edges of a printed pattern is typically non-linearly distributed at a microscopic level. This may create a shadow effect in the areas around printed patterns. The level of grey of the pixels in these areas is likely to be above the threshold. In order to include the areas around the printed patterns in the respective alpha masks α₁ and α₂ by assigning a value of 0 to those pixels, a binary dilation (also known as Minkowski addition) is applied to dilate areas of value 0 in each binary image. The resulting alpha masks α₁ and α₂ represent printed parts wider than their true width in order to include surrounding grey pixels into the masks α₁ and α₂. The dilation of a set X by a structuring element B is:

D_{B}(X)={x:B(x)∩X≠φ} (1)

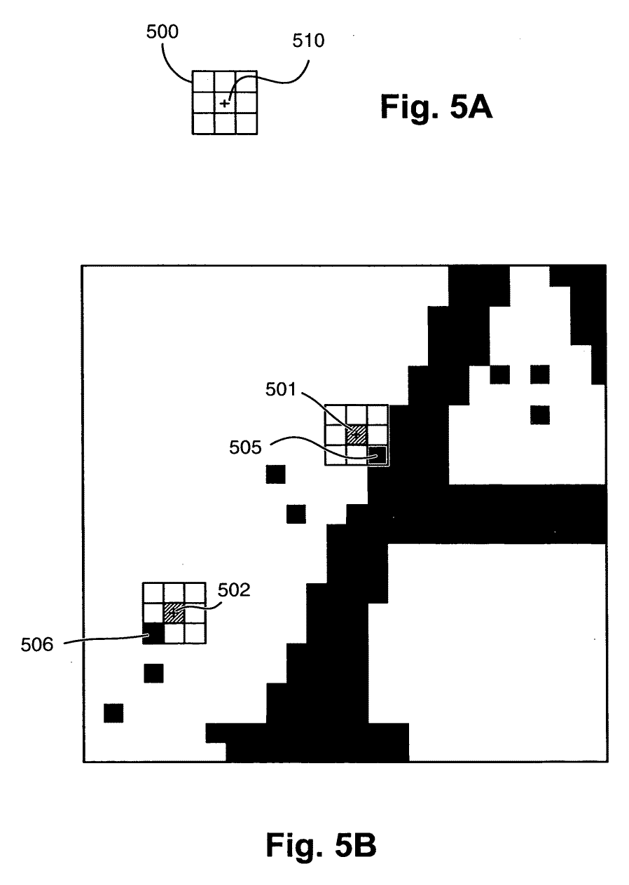

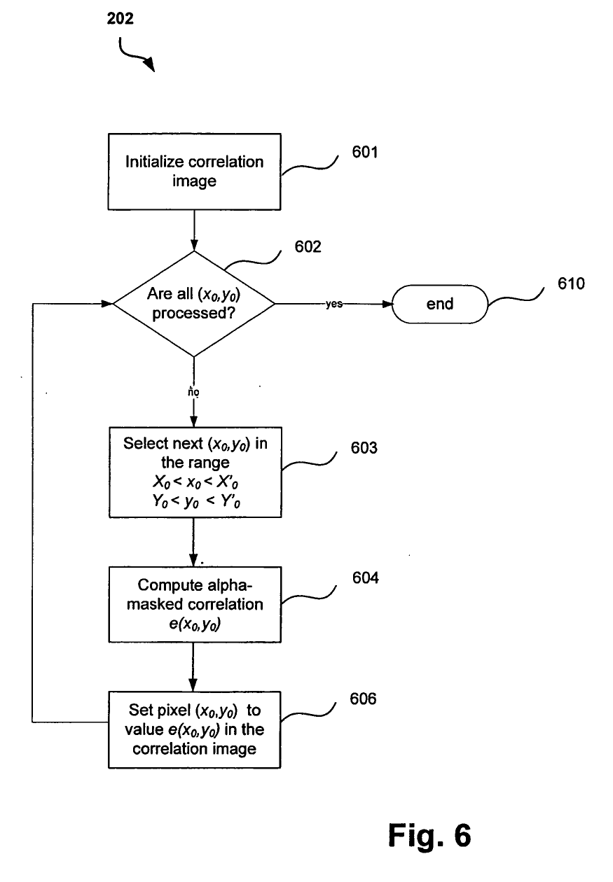

In one embodiment, the structuring element B is a square 3×3 pixel grid 500 covering 8 pixels around its origin 510, as shown in FIG. 5A. By scanning each of the binary images with the square 3×3 pixel grid 500, for each position of origin 510, if a black pixel (pixel with value 0) appears in the grid 500, then the resulting alpha mask's pixel corresponding with the origin 510 is set to 0. For instance, as is illustrated in FIG. 5B, when the origin 510 of the structuring element is located at position 501, the pixel at position 501 is set to 0 because a black pixel 505 appears in the structuring element. When the origin 510 is located in position 502, the pixel in at position 502 is also set to 0 because a black pixel 506 appears in the structuring element. FIG. 4C shows the alpha mask produced through dilution from the example binary image shown in FIG. 4B.

In an alternative embodiment, the mask value associated with a pixel can be set to a non-binary value. The mask value can be set to a non-binary value based on the number of pixels within the structuring element having intensities below the threshold. For example, the mask value corresponding to a pixel at position 501 can be determined in accordance with the following formula:

$$1 - \frac{\begin{matrix}number of pixels within structuring \\ element with intensity less than threshold\end{matrix}}{number of pixels within structuring element}$$

At the completion of step 201 (FIG. 3) alpha masks α₁ and α₂ are produced which associate a value of 0 or 1 to every pixel of the candidate digital signature 1415 and the reference digital signature 1412 respectively. As will be described below, pixels in the digital signatures 1415 and 1412 with an alpha mask value of 0 associated therewith will be ignored in the computation of the match strength value 1425.

Various other methods may be used to produce the alpha masks α₁ and α₂, for example, different structuring elements may be used. Also, mathematical morphology processing or image filtering methods may be used to produce the alpha masks α₁ and α₂ from the digital signatures 1415 and 1412. The alpha masks α₁ and α₂ may alternatively be created based on the output of an optical character recognition system. Less sophisticated alpha masks α₁ and α₂ may simply use polygons bounding the printed areas.

The above described alpha masks α₁ and α₂ are binary. Non-binary alpha masks α₁ and α₂ having fractional values between 0 and 1 may also be used to associate a degree of influence to each pixel of the digital signatures 1415 and 1412. In this case a non-binary dilation is applied. The values of the non-binary alpha masks α₁ and α₂ may for example be a function of the estimated distance to the border of the dilated area.

Step 202 follows where the candidate digital signature 1415 and reference digital signature 1412 are correlated. During the correlation, the alpha masks α₁ and α₂ are used to control the level of influence attributed to the pixels of the digital signatures 1412 and 1415.

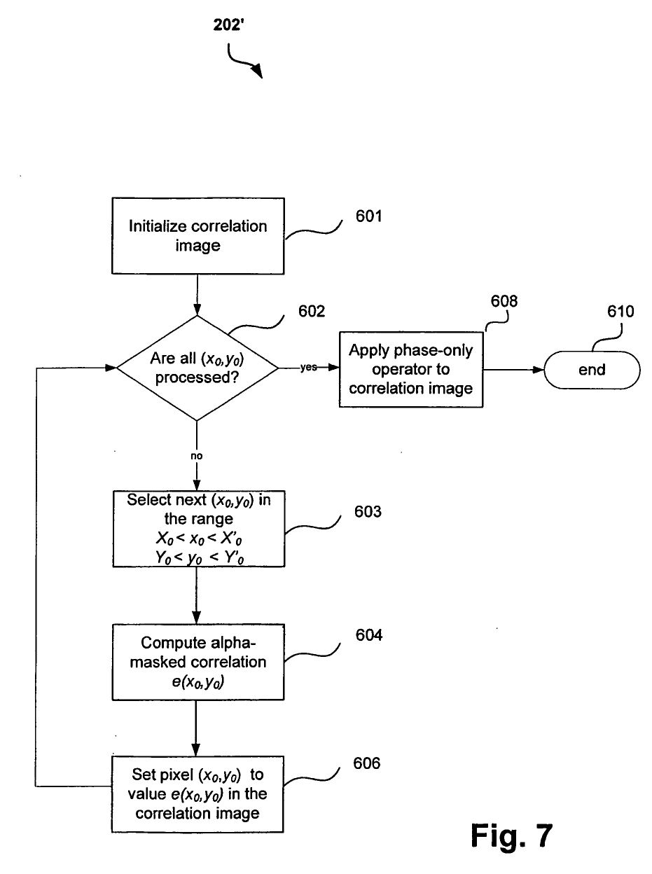

FIG. 6 shows a schematic flow diagram of step 202 where the digital signatures 1412 and 1415 are correlated. Step 202 starts in sub-step 601 where a correlation image is initialized with zero values. Sub-step 602 determines whether every possible relative translation (x₀, y₀) between the digital signatures 1412 and 1415 in the range:

X₀+K<x₀<X′₀−K (2)

Y₀+K<y₀<Y′₀−K (3)

wherein

X₀=−½(min_width+max_width); (4)

X′₀=½(min_width+max_width); (5)

Y₀=−½(min_height+max_height); (6)

Y′₀=½(min_height+max_height); (7)

has been processed. The constant min_width is the lesser of the widths of the two digital signatures 1412 and 1415, min-height is the lesser of the heights of the two digital signatures 1412 and 1415, max width is the greater of the widths of the digital signatures 1412 and 1415 and max_height is the greater of the heights of the two digital signatures 1412 and 1415. Constants K and K′ control the minimum overlap of the digital signatures 1412 and 1415 (for instance, they may be both set at 10 pixels).

If it is determined that not all translations (x₀, y₀) have been processed then, in sub-step 603, a next translation (x₀, y₀) is selected. An alpha masked correlation value e(x₀,y₀) is then determined in sub-step 604 as follows:

$$e ( {x}_{0} , {y}_{0} ) = {\sum }_{x , y} {( {f}_{1} ( x , y ) - {f}_{2} ( x - {x}_{0} , y - {y}_{0} ) )}^{2} {α}_{1} ( x , y ) {α}_{2} ( x - {x}_{0} , y - {y}_{0} ) \qquad ( 8 )$$

wherein f₁ and f₂ represent the digital signatures 1415 and 1412 respectively. The alpha masked correlation value e(x₀,y₀) is assigned to the pixel (x₀,y₀) in the correlation image in step 604 before step 202 returns to sub-step 602.

If it is determined in sub-step 602 that all translations (x₀, y₀) have been processed then step 202 ends in sub-step 610.

It is possible to reduce the computation cost of Equation (8) by using spectral correlation rather than spatial correlation. The alpha masked correlation value e(x₀,y₀) may be expressed as a sum of three correlations by expanding the square term in Equation (8) and distributing:

$$e ( {x}_{0} , {y}_{0} ) = {\sum }_{x , y} {α}_{1} ( x , y ) {f}_{1}^{2} ( x , y ) {α}_{2} ( x - {x}_{0} , y - {y}_{0} ) - 2 {\sum }_{x , y} {f}_{1} ( x , y ) {f}_{2} ( x - {x}_{0} , y - {y}_{0} ) {α}_{1} ( x , y ) {α}_{2} ( x - {x}_{0} , y - {y}_{0} ) + {\sum }_{x , y} {α}_{1} ( x , y ) {f}_{2}^{2} ( x - {x}_{0} , y - {y}_{0} ) {α}_{2} ( x - {x}_{0} , y - {y}_{0} ) \qquad ( 9 )$$

Let the symbol \textcircled{×} denote the correlation of two functions g and h as follows:

$$( g ⊗ h ) ( m ) = {\sum }_{x} g ( x ) {h}^{*} ( x - m ) \qquad ( 10 )$$

wherein * is the complex conjugate. Equation (9) may be re-written as a sum of three correlations as follows:

e(x₀,y₀)=(α₁f₁²\textcircled{×}α₂31 2α₁f₁\textcircled{×}α₂f₂+αₐ\textcircled{×}f₂²α₂)(x₀,y₀) (11)

Correlation may also be expressed as the inverse Fourier transform of a product of Fourier transforms, as follows:

g\textcircled{×}h= [symbol] ⁻¹( [symbol] (g)· [symbol] *(h)) (12)

wherein [symbol] (g) denotes the Fourier transform of function g.

Therefore, Equation (11) may as well be computed using six forward Fast Fourier Transforms (FFT) and one inverse FFT. The direct evaluation of the convolution summation in Equation (8) requires N² operations, where N is the number of pixels of the larger image. Using an FFT advantageously provides an O(N log(N)) method to compute the same correlation.

The discrete Fourier transform always treats an image as if it was part of a periodically replicated array of identical images extending horizontally and vertically to infinity. This often induces strong edge effects between the neighbours of the periodic array. A common technique for reducing these effects consists in “zero-padding” the image, i.e. windowing the image with a border of zeros. This processing may be included prior to step 202.

In the current embodiment, the alpha-masked correlation defined in Equation (8) uses a squared kernel. However various other definitions of alpha-masked correlation, for instance using sinusoidal kernels, could be used.

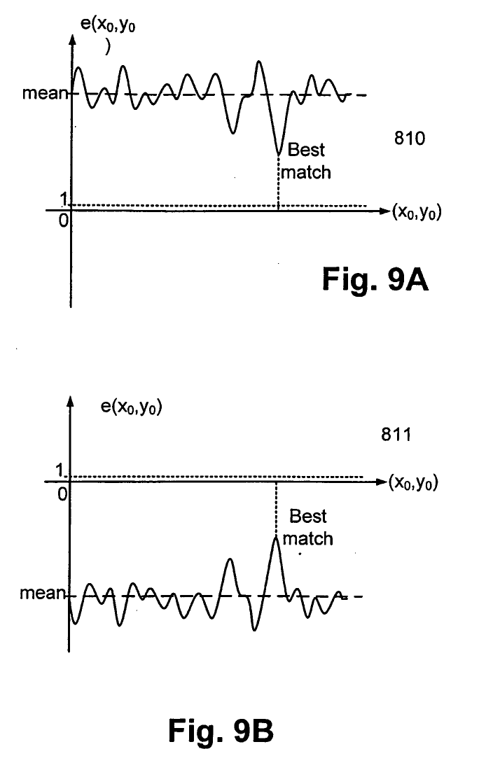

Referring again to FIG. 3, step 203 determines the match strength value 1425 and a corresponding translation value S=(x₀^{P}, y₀^{P}). FIG. 8 shows a schematic flow diagram of step 203 where the match strength value 1425 and the translation value S are determined. The correlation image calculated in step 202 has pixel values e(x₀,y₀), which are all positive. This is because Equation (8) is basically a sum of square errors. The pixel in the alpha masked correlation image e(x₀,y₀) with a minimum value corresponds to the best alpha-masked correlation.

Step 203 starts in sub-step 801 where each pixel value of the correlation image e(x₀,y₀) is negated. Next, in sub-step 802, the mean of the pixel values is subtracted from each pixel value. Finally, in sub-step 803, the value of each pixel of the resulting image is rescaled by dividing each pixel value by a real value L, thereby causing the average energy of the pixels to be 1. The real value L is defined as follows:

$$L = \sqrt{\frac{{\sum }_{{x}_{0} , {y}_{0}} {e}^{2} ( {x}_{0} , {y}_{0} )}{Nbpixel}} \qquad ( 13 )$$

The distribution of the values in the resulting image has zero mean and a standard deviation of 1. The height of the peak value in the resulting image provides the match strength value 1425, and the coordinates of that peak value provides the translation value S=(x₀^{P}, y₀^{P}). The match strength value 1425 may be interpreted as the number of standard deviations away from the mean value, or equivalently:

$$M = {max}_{{x}_{0} , {y}_{0}} ( \frac{1}{L} ( m - e ( {x}_{0} , {y}_{0} ) ) ) \qquad ( 14 )$$

wherein m denotes the mean of the correlation image e(x₀,y₀). The translation value S=(x₀^{P}, y₀^{P}) gives an estimate of the closeness of the alignment of the two digital signatures 1415 and 1412.

In one embodiment the peak value in the resulting image which provides the match strength value 1425 is determined by scanning the image obtained in sub-step 803 with a moving widow, say of diameter 5 pixels, and determining the position of the window where the average value of the values in the windows is maximal. In this instance, the translation value S is determined based on the coordinates of the pixel at the centre of the moving window. However, any method of determining a global maximum in a 2 dimensional data may be used alternatively. In another embodiment, Fourier interpolation may be used to estimate the maximum with more accuracy.

With the definition of match strength 1425 used above, match strength values of around 2.0 indicate that no meaningful match had occurred. Substantially larger values indicate authenticity of the candidate physical medium 1405 with respect to the original physical medium 1400. Under normal conditions, there is a very substantial difference (of tens or hundreds of times) between the match strength of images with no match, and the match strength of authentic images.

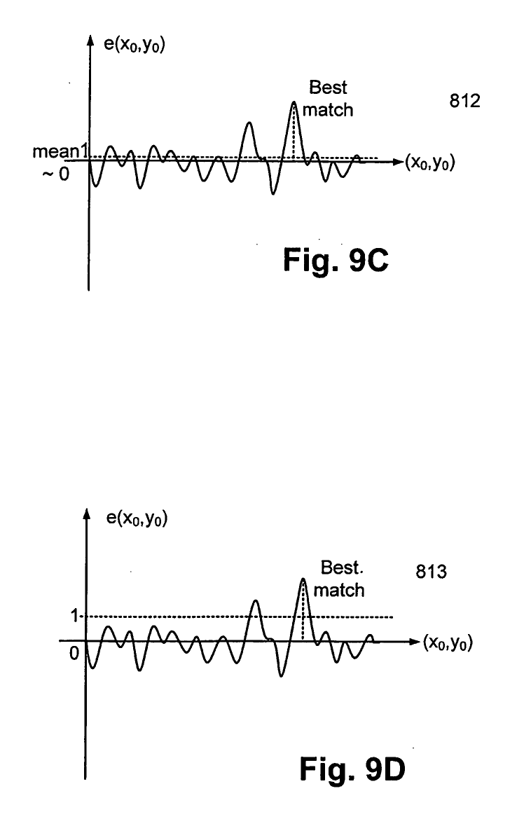

FIG. 9A shows an example of the distribution 810 of the correlation image values e(x₀,y₀) in a single dimension. After the negation of the values in step 801, the distribution 811 is that shown in FIG. 9B. After the mean of the pixel values is subtracted from each pixel value in step 802 the distribution 812 is shown in FIG. 9C. FIG. 9D shows the distribution 813 after the resealing of step 803. The value of the best alpha masked correlation pixel is substantially larger than 1.

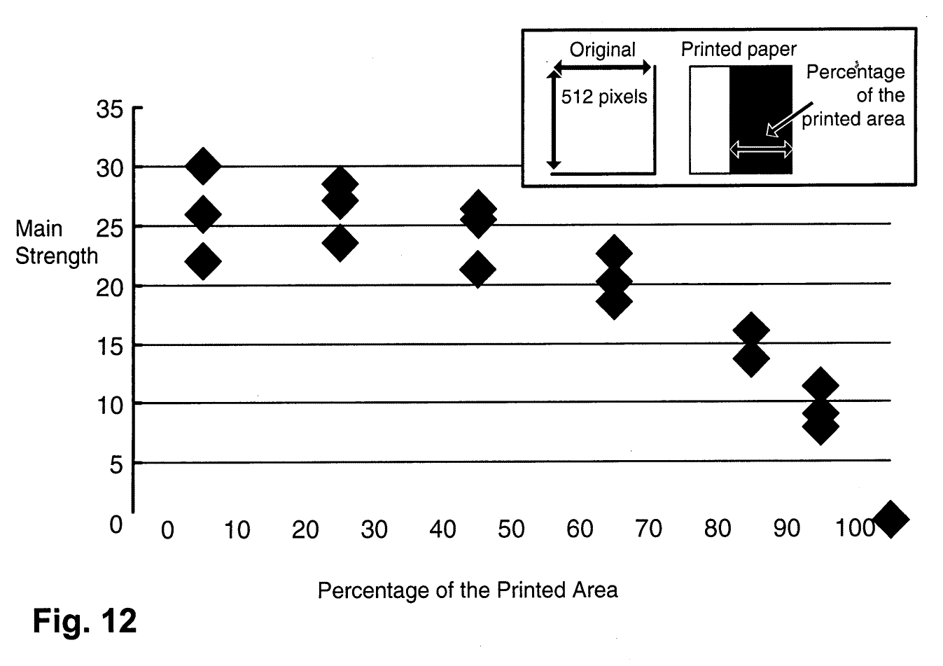

FIG. 12 is a graph showing the relationship between match strength and a measure of printed area coverage for three samples employing an alpha mask during generation of the match strength. The three samples use one type of coverage pattern. As seen in FIG. 12, the match strength remains usable for high coverage values.

Referring again to Equation (8) where the alpha masked correlation value e(x₀,y₀) is calculated, a different number of terms may be included in the calculation of each translation (x₀, y₀), with the number of terms being dependent upon how often values of alpha masks α₁ and α₂ are simultaneously equal to zero for that particular translation (x₀, y₀). As a result, the comparison of the alpha masked correlation values e(x₀,y₀) for two possible translations (x₀, y₀) are likely to be inequitable. To compensate for the number of values of alpha masks α₁ and α₂ that are simultaneously equal to zero for each translation (x₀, y₀), in one embodiment a normalizing denominator is introduced in step 604 (FIG. 6), and the alpha-masked correlation values e(x₀,y₀) are calculated as follows:

$$e ( {x}_{0} , {y}_{0} ) = \frac{\begin{matrix}{\sum }_{x , y} {( {f}_{1} ( x , y ) - {f}_{2} ( x - {x}_{0} , y - {y}_{0} ) )}^{2} \\ {α}_{1} ( x , y ) {α}_{2} ( x - {x}_{0} , y - {y}_{0} )\end{matrix}}{{\sum }_{x , y} {α}_{1} ( x , y ) {α}_{2} ( x - {x}_{0} , y - {y}_{0} )} \qquad ( 15 )$$

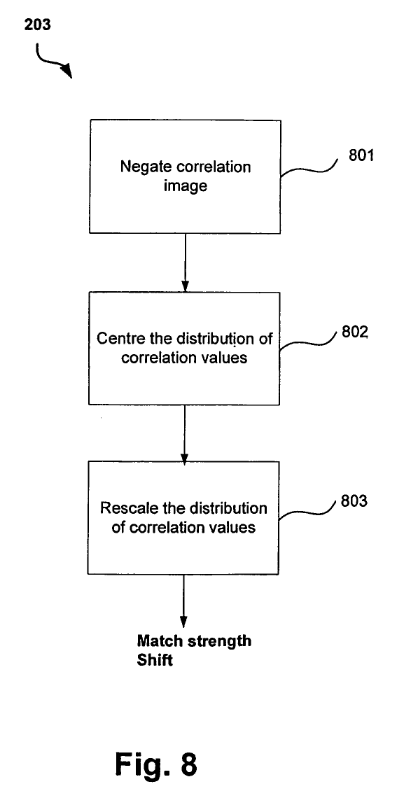

FIG. 7 shows a schematic flow diagram of an alternative step 202, denoted step 202′, for correlating the digital signatures 1412 and 1415. Step 202′ contains sub-steps 601 to 606 which are the same as sub-steps 601 to 606 of step 202 described with reference to FIG. 6. In step 202′, if it is determined in sub-step 602 that all translations (x₀, y₀) have been processed then, in sub-step 608, a phase-only operator is applied to the alpha masked correlation values e(x₀,y₀), thereby creating an alpha masked correlation image with sharper peaks. After sub-step 608, step 202′ terminates in sub-step 610.

A formulation of the phase-only operator is:

$$𝒫 ( f ) = {ℱ}^{- 1} ( \frac{ℱ ( f )}{\vert ℱ ( f ) \vert} ) \qquad ( 16 )$$

The phase-only operator first transforms an image f to the frequency domain, discards the modulus of the Fourier transformed image by dividing the Fourier transformed image by its own modulus, thereby preserving only the phase data, and finally transforms the result back to the spatial domain.

In yet a further embodiment the authentication system 100 compensates for non-constant background intensity in the scanned image. A physical medium when scanned may not have constant background intensity for various reasons, such as non-uniform illumination, paper curl, as well as physical and optical dot gain of printed characters. Optical dot gain causes a dot printed on paper to appear larger than the real size of the dot due to lateral diffusion of light in the paper surface.

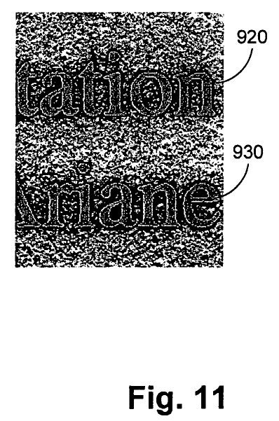

FIG. 11 shows an area of an image 920 obtained through scanning a sheet of paper with printed letters thereon. An alpha mask 930 is also shown in grey superimposed over the image 920. Due to optical dot gain, the borders of the printed characters are still visible around the alpha mask 930, even after a 1-pixel dilation of the printed characters has been applied to the image.

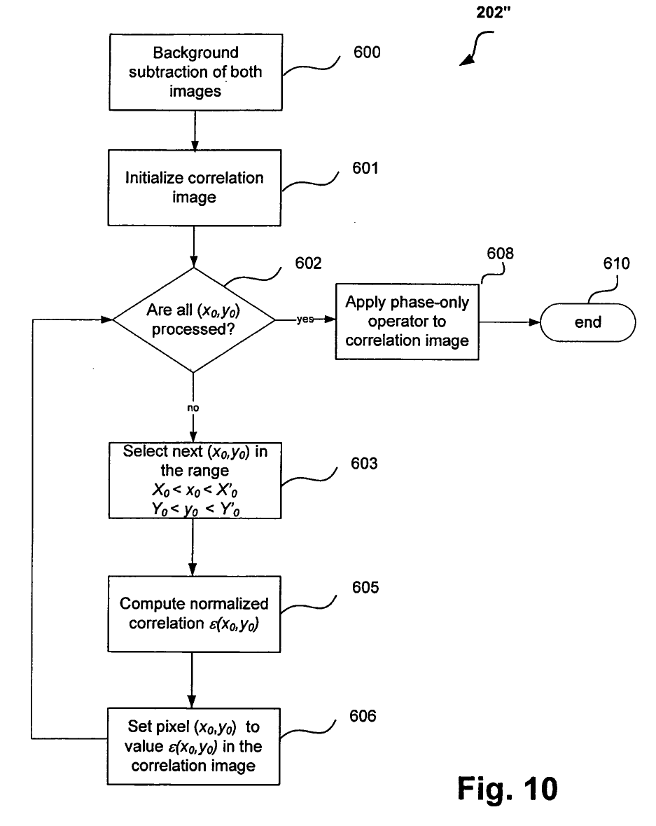

FIG. 10 shows a schematic flow diagram of another embodiment of step 202, denoted step 202″, where of the digital signatures 1412 and 1415 are alpha masked correlated in a manner such that scanner-dependent background intensities are removed before alpha masked correlation. Step 202″ starts in sub-step 600 where background subtraction is performed on each of the digital signatures 1412 and 1415. Due to the background subtraction the digital signatures 1412 and 1415 have zero local mean.

Before the background intensity can be subtracted, the (local) background intensity of the masked digital signatures 1412 and 1415 respectively has to be estimated. If f denotes the digital signature 1412 or 1415 and a denotes its corresponding alpha mask, the background intensity 7 is estimated by normalized averaging as follows:

$$\overline{f} = \frac{blur ( f \cdot α )}{blur ( α )} \qquad ( 17 )$$

where blur is a low-pass filtering operation and (.) is a pixel-wise multiplication operator. A blurring kernel is used in the low-pass filtering operation, with the size of the blurring kernel being large enough to filter out the high-frequency variation of the image “texture”, while the low-frequency variation of the background intensity is still retained. Preferably a box blur filter is used with a kernel size N between 13 and 23. A two-dimensional box blur filter may be implemented very efficiently in a separable fashion by implementing two one dimensional blur filters. Each one dimensional filter produces the average of N consecutive pixels within a moving window. Since this window is moved across the image only one pixel at a time, the average of the new window may be computed from the average of the previous window by subtracting the pixel value of the pixel no longer included in the window, and adding the pixel value of the newly included pixel. In this way, a box filter of arbitrary kernel size N only costs four additions and one multiplication (for normalization) per pixel.

Various alternatives exist to achieve background estimation, and include for example mathematical morphology operators such as erosion, dilation, opening, and closing.

Sub-steps 601, 602 and 603 then initialize the alpha masked correlation image, determine whether every possible relative translation (x₀, y₀) has been processed, and select a next translation (x₀, y₀) when more translations remain for processing. Sub-steps 601 to 603 are described in detail with reference to FIG. 6.

After sub-step 603 a normalized correlation value ε(x₀, y₀) at the present translation (x₀, y₀) is calculated in sub-step 605 as:

$$ɛ ( {x}_{0} , {y}_{0} ) = - 2 {\sum }_{x , y} {f}_{1} ( x , y ) {f}_{2} ( x - {x}_{0} , y - {y}_{0} ) {α}_{1} ( x , y ) {α}_{2} ( x - {x}_{0} , y - {y}_{0} ) \qquad ( 18 )$$

As an alternative to Equation (18), a normalized correlation value ε(x₀, y₀) may be calculated using a normalizing denominator to compensate for the number of values of alpha masks α₁ and α₂ that are simultaneously equal to zero for each translation (x₀, y₀) as follows:

$$ɛ ( {x}_{0} , {y}_{0} ) = - \frac{2 {\sum }_{x , y} {f}_{1} ( x , y ) {f}_{2} ( x - {x}_{0} , y - {y}_{0} ) {α}_{1} ( x , y ) {α}_{2} ( x - {x}_{0} , y - {y}_{0} )}{{\sum }_{x , y} {α}_{1} ( x , y ) {α}_{2} ( x - {x}_{0} , y - {y}_{0} )} \qquad ( 19 )$$

Similar to alpha-masked correlation in the first embodiment, Equation (19) may be re-written as a ratio of two Fourier correlations as follows:

$$ɛ ( {x}_{0} , {y}_{0} ) = - 2 ( \frac{{α}_{1} {f}_{1} ⊗ {α}_{2} {f}_{2}}{{α}_{1} ⊗ {α}_{2}} ) ( {x}_{0} , {y}_{0} ) . \qquad ( 20 )$$

Note that the numerator of normalized correlation in Equations (19) and (20) differs from the alpha-masked correlation in Equation (11) by an image-dependent offset. This offset only marginally affects the topology of the correlation image, hence normalized correlation produces a correlation peak at the same location as that of normalized alpha-masked correlation.

The normalized correlation value ε(x₀, y₀) is then assigned to the pixel (x₀,y₀) in the correlation image in step 606 before step 202″ returns to sub-step 602. If it is determined in sub-step 602 that all translations (x₀, y₀) have been processed then, in sub-step 608, a phase-only operator is applied to the alpha masked correlation values e(x₀,y₀) in a manner described with reference to FIG. 7, thereby creating a alpha masked correlation image with sharper peaks. After sub-step 608, step 202″ terminates in sub-step 610.

Since the local average of a background subtracted image is zero, scanner bias is automatically corrected for. With the bias removed, scanner gain only affects the correlation result by a gain factor without changing its correlation peak strength. Background subtraction therefore offers gain and bias compensation. Another advantage of background subtraction is the removal of the dot gain effect. Since the image intensities around printed characters are no longer darkened by the dot gain effect, the alpha masks can include more pixels for a better matching result.

In a further embodiment, when comparing the reference digital signature 1412 and the candidate digital signature 1415 in step 1420, differences resulting from scanning the digital signatures 1412 and 1415 using different scanners are accounted for. The photoelectric transforms operated by two different scanners or photocopiers never treat the same physical medium equally. As a consequence, the distributions of the pixel intensities obtained when scanning a document with two different scanners are likely to differ in amplitude (or so-called gain), as well as in average (or so-called bias). It is therefore advantageous for step 202 to account for the specific gain and bias of the scanner 116 or photocopier.

Let f denote the original area of the physical medium before it is scanned to create the reference digital signature 1412, let f₁ denote the image of reference digital signature 1412, and let f₂ denote the image of the candidate digital signature 1415. Image f₂ is either a copy of the area of the physical medium f with a different scanner and possibly some markings, or a forgery. Assuming that image f₂ is authentic, each of images f₁ and f₂ is derived from area f by applying a different gain (respectively G₁ and G₂) and bias (respectively B₁ and B₂). Each of the two scanners also introduces an unknown noise v₁ and v₂:

f₁(x,y)=G₁(f(x,y)+B₁+v₁(x,y)) (21)

f₂(x,y)=G₂(f(x,y)+B₂+v₂(x,y)) (22)

If image f₂ is authentic, the noises v₁ and v₂ constitute the components that most differentiate the two images.

Defining a correlation error directly using images f₁ and f₂ would be meaningless for several reasons:

1. The gains G₁ and G₂ act as a different scaling factors applied to the original area f. In order to define a valid correlation error, images f₁ and f₂ have to be considered against a common scale, such as the geometric mean of the gains G₁ and G₂: \sqrt{G₁G₂}. Denote

$$a = \frac{\sqrt{{G}_{1}}}{\sqrt{{G}_{2}}} .$$

As image f₁ initially refers to the gain G₁, image f₁ is multiplied by 1/a in order to refer to the scale \sqrt{G₁G₂}. Similarly, as image f₂ initially refers to the gain G₂, image f₂ is multiplied by a in order to refer to the scale \sqrt{G₁G₂}.

2. The images f₁ and f₂ are characterized by different biases B₁ and B₂. The correlation error should therefore take into account the difference in bias between the two images f₁ and f₂. Denote b=B₁−B₂.

3. Finally, this model is only valid if the gains G₁ and G₂ have the same sign. However, this might not be true in practice. Consider for instance that the intensity distributions of f₁ and f₂ are represented on an interval [−100; 100]. In this instance, the gains G₁ and G₂ may have different signs. This typically happens when two different scanners have illuminated the paper from different directions, which causes contrast reversal.

Therefore the following correlation error is defined:

$$e ( a , b ) = {\sum }_{x , y} {( {af}_{1} ( x , y ) \pm \frac{1}{a} {f}_{2} ( x - {x}_{0} , y - {y}_{0} ) - b )}^{2} {α}_{1} ( x , y ) {α}_{2} ( x - {x}_{0} , y - {y}_{0} ) \qquad ( 23 )$$

The following notation is now introduced:

Cₘₙ=α₁f₁^{m}\textcircled{×}α₂f₂ⁿ (24)

A formulation equivalent to Equation (23) is obtained by expanding the square and writing Equation (23) as a sum of correlations:

$$e ( a , b ) = {a}^{2} {C}_{20} \pm 2 {C}_{11} + \frac{1}{{a}^{2}} {C}_{02} - 2 b ( {aC}_{10} \pm \frac{1}{a} {C}_{01} ) + {b}^{2} {C}_{00} \qquad ( 25 )$$

In step 203 where the match strength value 1425 and the corresponding translation value S=(x₀^{P}, y₀^{P}) are determined, the pixel of the correlation image with the minimum value corresponds to the translation (x₀^{P}, y₀^{P}) that produces the best correlation. The value of that minimum pixel is:

$$E = {min}_{a , b} ( e ( a , b ) ) \qquad ( 26 )$$

Equation (26) is quadratic in b. By definition, the coefficient Coo is a sum of products of positive functions (the alpha masks) and therefore is positive. Hence the quadratic form of Equation (26) is convex and the minimum for all the possible values of E occurs when:

$$b = \frac{{aC}_{10} \pm \frac{1}{a} {C}_{01}}{{C}_{00}} . \qquad ( 27 )$$

Substituting Equation (27) in Equation (26) provides:

$$\begin{matrix}E = {min}_{a} ( {a}^{2} {C}_{20} \pm 2 {C}_{11} + \frac{1}{{a}^{2}} {C}_{02} - \frac{{( {aC}_{10} \pm \frac{1}{a} {C}_{01} )}^{2}}{{C}_{00}} ) & ( 28 ) \\ = \frac{1}{{C}_{00}} ( {a}^{2} ( {C}_{20} {C}_{00} - {C}_{10}^{2} ) \pm 2 ( {C}_{11} {C}_{00} + {C}_{10} {C}_{01} ) + \frac{1}{{a}^{2}} ( {C}_{02} {C}_{00} - {C}_{01}^{2} ) ) & ( 29 )\end{matrix}$$

Arithmetic geometric means inequality establishes that

$$\frac{{x}_{1} + {x}_{2}}{2} \geq \sqrt{{x}_{1} \cdot {x}_{2}} , ∀ {x}_{1} , {x}_{2} ∈ {+}^{} .$$

Note that this theorem requires each term of the mean to be positive. This theorem is applied to the first and third terms of the sum of Equation (29) in order to determine a lower bound E for all values of b. It is first demonstrated that the requirement on the sign of the terms is verified. By definition:

$$\begin{matrix}{C}_{20} {C}_{00} ( {x}_{0} , {y}_{0} ) = {\sum }_{x , y} {α}_{1} ( x , y ) {f}_{1}^{2} ( x , y ) {α}_{2} ( x - {x}_{0} , y - {y}_{0} ) {\sum }_{x , y} {α}_{1} ( x , y ) {α}_{2} ( x - {x}_{0} , y - {y}_{0} ) \\ and , & ( 30 ) \\ {C}_{10}^{2} ( {x}_{0} , {y}_{0} ) = {( {\sum }_{x , y} {α}_{1} ( x , y ) {f}_{1} ( x , y ) {α}_{2} ( x - {x}_{0} , y - {y}_{0} ) )}^{2} & ( 31 )\end{matrix}$$

The Cauchy-Schwartz inequality establishes that:

(Σaᵢ²)(Σbᵢ²)≧(Σaᵢbᵢ)² (32)

Set:

aᵢ(x,y,x₀,y₀)=f₁(x,y)\sqrt{α₁(x,y)α₂(x−x₀,y−y₀)} (33)

and

bᵢ(x,y,x₀,y₀)=\sqrt{α₁(x,y)α₂(x−x₀,y−y₀)} (34)

The Cauchy-Schwartz inequality then provides:

C₂₀C₀₀(x₀,y₀)≧C₁₀²(x₀,y₀) (35)

It can similarly be demonstrated that:

C₀₂C₀₀(x₀,y₀)≧C₀₁²(x₀,y₀) (36)

Therefore, it is possible to apply the arithmetic geometric means inequality to Equation (29) to obtain:

$$\begin{matrix}E \geq \frac{2}{{C}_{00}} \sqrt{( {a}^{2} ( {C}_{20} {C}_{00} - {C}_{10}^{2} ) \frac{1}{{a}^{2}} ( {C}_{02} {C}_{00} - {C}_{01}^{2} ) )} \pm 2 ( {C}_{11} {C}_{00} + {C}_{10} {C}_{01} ) & ( 37 ) \\ \geq \frac{2}{{C}_{00}} \sqrt{( {C}_{20} {C}_{00} - {C}_{10}^{2} ) ( {C}_{02} {C}_{00} - {C}_{01}^{2} )} - 2 \vert {C}_{11} {C}_{00} + {C}_{10} {C}_{01} \vert & ( 38 )\end{matrix}$$

The equality is reached when:

C₂₀C₀₀−C₁₀²=C₀₂C₀₀−C₀₁². (39)

Therefore, the following value is the minimum value E independent of the value of a or b:

$$E = \frac{2}{{C}_{00}} \sqrt{( {C}_{20} {C}_{00} - {C}_{10}^{2} ) ( {C}_{02} {C}_{00} - {C}_{01}^{2} )} - 2 \vert {C}_{11} {C}_{00} + {C}_{10} {C}_{01} \vert \qquad ( 40 )$$

Equation (40) therefore provides an alternative to determine the alpha-masked correlation image in step 202 which accounts for the gain and bias that characterize the images.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

The claims defining the invention are as follows:

1. A method of authenticating a physical medium, said method comprising steps for:
retrieving a reference digital signature previously determined based upon visual characteristics of an area of a reference physical medium;
determining a candidate digital signature based upon visual characteristics of a selected area of said physical medium, said selected area of said physical medium being at least partly corresponding to said selected area of said reference physical medium; and
comparing said candidate digital signature with said reference digital signature,
wherein said physical medium includes a substantial amount of markings additional to markings included in said reference physical medium.

2. A method of authenticating a physical medium, said method comprising the steps for:
retrieving a reference digital signature previously determined based upon visual characteristics of an area of a reference physical medium;
determining a candidate digital signature based upon visual characteristics of a area of said physical medium, said area of said physical medium being at least partly corresponding to said area of said reference physical medium;
determining weight values associated with different parts of at least one of said areas; and
comparing said candidate digital signature with said reference digital signature, wherein a contribution of said parts in the comparison is based upon said one or more weight values.

3. A method according to claim 1, wherein said weight values are dependent upon intensity values in said digital signatures.

4. A method according to claim 1, wherein said digital signatures are determined by scanning said reference medium to obtain digital images of each area.

5. A method according to claim 4 wherein a background intensity is removed from each digital image before said comparing step.

6. A method according to claim 5 wherein said background intensities are estimated before removal.

7. A method according to claim 1 wherein said markings are due to one or more of: printing, stamping, signing, stapling, binding, handwriting, signing, sealing, truncating, crushing.

8. A method according to claim 1 wherein said comparison is quantified to provide a level of authenticity.

9. Apparatus for authenticating a physical medium, said apparatus comprising:
means for retrieving a reference digital signature previously determined based upon visual characteristics of an area of a reference physical medium;
means for determining a candidate digital signature based upon visual characteristics of an area of said physical medium, said area of said physical medium being at least partly corresponding to said area of said reference physical medium;
means for determining weight values associated with different parts of at least one of said areas; and
means for comparing said candidate digital signature with said reference digital signature, wherein a contribution of said parts in the comparison is based upon said one or more weight values.

10. A computer program product including a computer readable storage medium having recorded thereon a computer program for implementing a method of authenticating a physical medium, said method comprising the steps for:
retrieving a reference digital signature previously determined based upon visual characteristics of an area of a reference physical medium;
determining a candidate digital signature based upon visual characteristics of a area of said physical medium, said area of said physical medium being at least partly corresponding to said area of said reference physical medium;
determining weight values associated with different parts of at least one of said areas; and
comparing said candidate digital signature with said reference digital signature, wherein a contribution of said parts in the comparison is based upon said one or more weight values.
